(19) United States
(12) Patent Application Publication
(10) Pub. No.: US 2015/0259117 A1
(43) Pub. Date: Sep. 17, 2015

(54) System and Method for Packaging

(71) Applicant: FL Packaging Designs LLC, Orlando, FL (US)

(72) Inventors: Philip Wesby, Stratford-upon-Avon (GB); John Luisi, Lancashire (GB); Richard Luisi, Englewood, FL (US)

(21) Appl. No.: 14/714,884

(22) Filed: May 18, 2015

Related U.S. Application Data
(63) Continuation of application No. 13/944,290, filed on Jul. 17, 2013, now abandoned.
Application No. 13/944,290 is a continuation of application No. PCT/GB2012/000079, filed on Jan. 27, 2012.

(30) Foreign Application Priority Data
Jan. 31, 2011 (GB) 1101594.8
Jun. 13, 2011 (GB) 1109789.6
Jan. 10, 2012 (GB) 1200349.7

(51) Int. Cl. B65D 77/04; A45C 11/16; B31B 3/26; A47G 21/00; B65D 85/36; B65D 81/34; B65D 85/72; B65D 77/32

(52) U.S. Cl. CPC B65D 77/0433; B65D 85/72; A45C 11/16; B65D 77/32; A47G 21/001; B65D 85/36; B65D 81/3453; B31B 3/26; B65D 2585/366

(57) ABSTRACT

A system for packaging forming a container can provide an improved form of food packaging. The container includes a base element and at least two lateral side elements, and forms a tray element. The tray element defines an open cavity for containing contents, and has a back and front edge. At least one of the lateral side elements has at least one moveable element integrated with, and forming an extension of, the lateral side element at a first fixed end of the moveable element(s). The moveable element(s) is/are capable of being folded into the cavity and around the contents, and is of a length such that the second, free end of the moveable element(s) extend(s) around the contents to the front edge of the tray element. The second free end is capable of being pulled to cause the contents to move towards the front edge of the tray element.

### PRIORITY

This patent application is a continuation of and claims priority from all priority dates of co-pending U.S. patent application Ser. No. 13/944,290, entitled “System and Method for Packaging,” filed Jul. 17, 2013, and naming Philip Wesby, John Luisi, and Richard Luisi as inventors. U.S. patent application Ser. No. 13/944,290 is a continuation of and claims priority to Patent Cooperation Treaty application PCT/GB2012/000079, entitled “System and Method for Packaging,” filed Jan. 27, 2012, and naming Philip Wesby, John Luisi, and Richard Luisi as inventors. PCT/GB2012/000079 claims priority to UK application number GB 1200349.7, filed Jan. 10, 2012, UK application number GB 1109789.6, filed Jun. 13, 2011, and UK application number 1101594.8 filed Jan. 31, 2011. The disclosures of each of these applications are incorporated herein by reference in their entirety.

### TECHNICAL FIELD

The invention relates to a system and method for packaging. More particularly, it relates to a system and method for packaging, which can provide a versatile dispensing solution for fresh food packaging. In particular, the food packaging solution is directed towards an improved form of clamshell packaging for fast foods such as hamburgers, pizzas and the like. In particular, the invention is directed towards improved techniques for dispensing food in clamshell packaging, which makes it possible to eat the food from the packaging without touching the food with one's hands.

### BACKGROUND ART

Generally, packaging systems for food are known. In the area of fast food, innovations have focused upon creating lightweight packaging materials, which are easy to manufacture and to fold out and construct from flat-pack designs. Where this packaging is directed towards warm food, insulating materials comprising the right type of sterile surface have been used for these packaging. Additionally, open tray packaging provides a means to hold the contents of packaging to enable easy insertion into a larger container as well as the means for easy extraction.

Essentially, for fast foods the area of innovation has focused upon the areas of ease of re-construction from flat-pack material, insertion (e.g., food insertion) and general ease of transport. Few designs have addressed the need for ease of extraction of the food considering that many foods may contain sauces and loose food elements. The evolution of solutions for fast food packaging, which fail to address adequately the issues solved by the current invention can be seen in the following documents. U.S. Pat. No. 4,472,896 to Brauner and Watson, published 25th Sep. 1984 describes a carton for a hamburger comprising the standard clamshell design with flat surfaces for displaying a brand name or the content type. This solution offers no improved means for extracting the food while reducing the chances of food being spilled.

An alternative form of hamburger packaging is shown in United Kingdom patent GB 2307678 to Monk and Davison published 4th Jun. 1997. This flat-pack design comprises a clamshell having interlocking flaps and slots and a front edge, which can divide into three separate tabs and thereby offer a convenient means to close the clamshell. This packaging concept only comprises a very basic design, which cannot address the problems solved by the current invention.

Pizzas are a growing and popular fast food market. Consumers frequently order take-away pizzas by phone, which are delivered to their home address, or alternatively, they buy pizzas to take away at the pizza restaurant themselves. The main challenges with pizza delivery are keeping the pizza warm. While the use of cardboard packaging, which comprises good insulator properties serves to limit heat loss, the application of the current invention greatly reduces the loss of heat from the pizza, once packaged.

In patent application WO 2005123545 to Kuhn and Pizzitola is shown a cardboard flat-pack pizza box design suitable for home delivery, which comprises interlocking sides with extended flaps comprising hand slots. This design does not adequately address the heat loss problems associated with take away pizzas because as soon as the pizza box is opened, a substantial amount of heat is unnecessarily lost froth the warm pizza in a very short time.

In Canadian patent CA 2068331 to Prosise and Bunke published 30th Jun. 1991 is shown a microwave food carton which is formed from a flat-pack carton and which comprises separate food-storage compartments wherein each comprises layers of microwave-susceptor material which serve to provide a heating surface in contact with the food when microwave energy falls upon the said surface. While this arrangement may be suitable for heating pre-cooked foods such as potato strips, this packaging does not address the application area of the current invention.

In Japanese patent abstract JP-A-2002 347756 to Kato Yoshikazu published 4th Dec. 2002 is shown a hamburger packaging design, which comprises a serrated strip positioned around halfway down the packaging such that the package may be conveniently opened by removing the serrated strip and thereby revealing the packaging. While this design serves to reveal a substantial part of the enclosed hamburger and to minimise hands from becoming covered with oil or sauces, no means exist to help a consumer extract food from the packaging.

In Japanese patent abstract JP-A-2003 072749 to Ishibashi Masatoshi published 12th Mar. 2003 is shown a hamburger container, which enables a consumer to eat the hamburger from the packaging itself. This design does not provide any means to assist the consumer to extract the food in a convenient way. In Japanese patent abstract JP-A-2003 063565 is shown an alternative hamburger container comprising a removable strip, which can be torn off continuously and in a spiral way to reveal more of the packaging contents as the hamburger is eaten. While this does serve to reduce getting the hands covered with oil or sauce while eating, and there is a minor improvement in heat loss, this solution is not as efficient or effective as the current invention.

In Japanese patent abstract JP-A-2004 276959 is shown a hamburger package, which comprises a means to assist the extraction of the food while eating. A lower part of the container comprises a compressible part which when pushed, lifts the hamburger upwards. This method, however, is greatly restricted and cannot serve to lift the food in a systematic way. Moreover, the resistance of the packaging material may serve to be difficult to push for those persons who may be physically challenged.

In WO2007132172 to Potgieter, is shown a moveable membrane design, which is applied to food packaging, tubular containers, plant trays and bread bins. The design of applicable to open tray and/or clamshell fast food packaging designs, which are used for dispensing hotdogs, hamburgers and pizzas and the like. In particular, the packaging designs incorporate separate moveable elements, which are difficult and time consuming to insert and or which waste substantial material during production.

From a commercial perspective, the fast food restaurant is focused upon cooking and packaging ordered food so that clients can be served quickly and efficiently, where product can be packaged and sold and conveniently transported away either in the hand for immediate consumption or perhaps additionally stored in a paper carrier bag. The packaging industry has not been particularly concerned with ease of extraction issues as perceived by the consumer. This is clearly an area, which may greatly differentiate points of sale, particularly if one type of packaging enhances the end user experience in a positive way. A food packaging innovation, which brings enhanced ease of extraction of the fast food from the packaging while efficiently containing potentially messy sauces, which can soil clothing, is a clear opportunity for a fast food sales outlet.

In other areas, consumers are often disappointed about clumsy packaging designs, which may require the food container to be inverted or shaken for food to be extracted. In particular, where there are physically challenged persons such as those suffering from a hand injury or even senior citizens who might not be able to use both hands, packaging which requires the use of two hands is not suitable. A packaging solution, which addresses this aspect opens up the food sales outlet to those physically challenged persons. Clearly, improved packaging designs can translate directly into increased sales.

Wherever a storage device is being pulled open, the means exists to improve the way in which the contents are delivered towards the consumer. Further to the limitations of existing methods used for food packaging and to storage systems in general, and so far as is known, no optimum system and method for a packaging system is presently available which is directed towards the specific needs of this problem area as outlined.

### Objects of the Invention

Accordingly, it is an object of the present invention to provide an improved system and method for packaging which can provide a versatile storage and dispensing solution for fast food takeaway clamshell packaging such as for hamburgers, pizzas, and the like.

It is a further object of one embodiment of the present invention to provide a system and method for packaging, which provides improved techniques for inserting and extracting food in a highly efficient way.

It is a further object of one embodiment of the present invention to provide a system and method for packaging, which is made of lightweight disposable material such as cardboard, or paper, or polystyrene, or similar materials suitable for food packaging.

It is a further object of one embodiment of the present invention to provide a system and method for packaging which is made of lightweight disposable materials such as one or a combination of metal foil(s), and or Mylar foil(s), and or paper, and or cardboard.

It is a further object of one embodiment of the present invention to provide a system and method for packaging, which is made of lightweight reusable material such as reusable plastic, in which case the packaging can be easily washed after use and reused.

It is a further object of one embodiment of the present invention to provide a system and method for fast food packaging comprising a clamshell design which is highly suitable for holding and eating food directly from the packaging without needing to touch the food with one's hands and thereby reducing contamination of the food and or getting sauces from the food on one's fingers.

It is a further object of one embodiment of the present invention to provide a system and method for packaging in which disposable packaging can be easily and quickly constructed from pre-printed and pre-cut flat-pack designs which interlock together from a single sheet without needing any adhesive.

It is a further object of one embodiment of the present invention to provide a system and method for packaging suitable for food in which the constructed package comprises an extended side which when folded comprises a movable element integrated with the package which assists with the extraction of food from the package.

It is a further object of one embodiment of the present invention to provide a system and method for packaging which is suitable for a new and improved clamshell design for fast food packaging which can be manufactured from a single sheet and which folds to form a clamshell box which also comprises an extended element which folds to form a moveable membrane integral with the box which passes around the hamburger or pizza or the like in the box and wherein the packaging is serrated such that the front part of the box can be removed to reveal the free end of the moveable membrane, which enables one to eat the food from the packaging.

It is a further object of the present invention to provide an improved system and method for packaging which can provide a versatile storage and dispensing solution for fast food takeaway open tray packaging such as for hotdogs, burritos, and the like.

It is a further object of one embodiment of the present invention to provide a system and method for packaging in general, which provides an improved technique for inserting the contents of packaging as well as an improved means to extract the contents in a highly efficient way.

It is a further object of one embodiment of the present invention to provide a system and method for packaging, which provides improved techniques for extracting food as it is eaten, in a highly efficient way.

It is a further object of one embodiment of the present invention to provide a system and method for packaging which is made of lightweight disposable materials such as one or a combination of metal foil(s), and or Mylar foil(s), and or paper, and or cardboard covered with a plastic film surface, and or cardboard.

It is a further object of one embodiment of the present invention to provide a system and method for fast food packaging comprising an open tray design which is highly suitable for holding and eating food directly from the packaging without needing to touch the food with one's hands and thereby reducing contamination of the food and or getting sauces from the food on one's fingers.

It is a further object of one embodiment of the present invention to provide a system and method for packaging in general comprising an open tray element further comprising a moveable membrane, which is highly suitable for holding the contents of a package wherein the tray element and contents can slide into an open box container, after which the tray element may be firmly attached to the outer packaging, and wherein the integral membrane provides an efficient means to extract the contents from the open tray element.

It is a further object of one embodiment of the present invention to provide a system and method for packaging which is suitable for a new and improved design for fast food tray packaging which can be manufactured from a single sheet and which folds to form a tray container which also comprises an extended element which folds to form a moveable membrane integral with the box which passes around the contents in the box and wherein the packaging is serrated such that the front part of the box can be removed to reveal the free end of the moveable membrane, which enables one to eat the food from the packaging.

Other objects and advantages of this invention will become apparent from the description to follow when read in conjunction with the accompanying drawings.

### SUMMARY OF THE EMBODIMENTS

The invention has greatest and most diverse application in the creation of a new range of food packaging and food storage clamshell dispensing containers, which can provide a more effective and suitable means to serve takeaway hot or cold fast food. The system and method of the current invention can be implemented in diverse ways to suit the nature of the food being packaged such that food can be more easily extracted from the packaging while minimising waste as well as addressing issues of insulation in the instance that the packaging is used for hot foods such as hamburgers and pizzas.

Certain of the foregoing and related objects are readily-attained according to the present invention by the provision of a novel system and method for packaging which has direct application to improvements in fast food clamshell packaging particularly for hamburgers, pizzas, and the like.

In particular, the invention is directed towards improved techniques for inserting and extracting food from a clamshell box in a highly efficient way.

The invention teaches a clamshell design which provides an integral movable element which is not separate from the clamshell box but which assists extraction of food from packaging while eating. In this way, food can be eaten conveniently from the packaging without getting the food contaminated as well as avoiding that food sauces mess hands or clothes.

In the preferred embodiment, the food packaging ideally comprises a single flat-pack clamshell design, which can be easily reconstructed by folding and clipping interlocking flaps together and wherein the design provides a highly efficient use of materials while providing an integral moveable element which folds to pass around the fast food contents and wherein a front serrated part of the box is removable to reveal the loose end of the moveable membrane such that the food is revealed and by pulling on the loose end the fast food can be pulled out of the box and eaten from the box without needing to touch the food directly.

Consequently, the clamshell packaging design enables fast food to be eaten from the packaging without needing full use of both hands and is thus highly suited for persons who are physically challenged or senior citizens.

The invention can also be realised using non-disposable materials such as flexible plastic, wherein the front part of the clamshell box is not removable but can be opened thus rendering it suitable for dish-washing wherein the packaging can be rewashed after use.

Other embodiments of the present invention, relate to a system and method for packaging. More particularly, it relates to a system and method for packaging, which can provide both a versatile dispensing solution for fast food packaging as well as a packaging insert for containers in general. In particular, the food packaging solution is directed towards an improved form of open tray packaging for fast foods such as hamburgers, hotdogs, burritos, baguettes, and the like. In particular, the invention is directed towards improved techniques for dispensing food in open tray packaging, which makes it possible to eat the food from the tray without touching the food with one's hands.

Embodiments of the invention have greatest and most diverse application in the creation of a new range of fast food packaging containers, which can provide a more effective and suitable means to serve takeaway hot or cold fast food. The system and method of the current invention can be implemented in diverse ways to suit the nature of the food being packaged such a food can be more easily extracted from the packaging while minimising.

Certain of the foregoing and related objects are readily-attained according to the present invention by the provision of a novel system and method for packaging which has direct application to improvements in fast food open tray packaging particularly for hotdogs, burritos, fajitas, and the like. In addition, the open tray packaging also provides a highly efficient means to enclose packaging contents such that the tray and contents can be easily inserted into an open packaging container.

In particular, in the context of fast food packaging, the invention is directed towards improved techniques for extracting the food from an open tray container in a highly efficient way.

In the context of packaging contents in general the open tray means provides a structure to partially enclose the contents of packaging such that the tray and contents can be easily inserted into open packaging.

The invention teaches an open tray design which provides an integral movable element which is not separate from the open tray structure but which assists extraction of the contents in the tray structure such as fast food from the open tray while eating. In this way, food can be eaten conveniently from the packaging without getting the food contaminated as well as avoiding that food sauces mess hands or clothes.

In one preferred embodiment with application to food, the packaging ideally comprises a single flat-pack open tray design, which can be easily reconstructed by folding and clipping interlocking flaps together or gluing flaps together and wherein the design provides a highly efficient use of materials while providing an integral moveable element which folds to pass around the fast food contents and wherein a front serrated side of the tray is removable, or folds down, to reveal the loose end of the moveable membrane such that the food is revealed and by pulling on the loose end the fast food can be pulled out of the tray and eaten from the tray without needing to touch the food directly.

Alternatively, the open tray container may comprise three sides and have no front side, wherein the membrane is integral with one of the sides and folds down to form the membrane around the food. The membrane extends around the food in the tray and the food is extracted out of the open front end of the tray.

Consequently, the fast food open tray packaging design enables fast food to be eaten from the packaging without needing full use of both hands and is thus highly suited for persons who are physically challenged or senior citizens.

For the application of the invention to packaging in general, the open tray mechanism provides an ideal solution for enclosing packaging contents such that the tray can be slid into outer packaging while leaving the membrane accessible when the outer packaging is opened. The open tray insert containing the contents is then firmly attached to outer packaging. The membrane passes around the contents of the tray such that when the outer packaging is opened, the membrane is revealed such that by pulling on the membrane, the contents from the tray within the outer packaging are easily extracted.

The invention can also be realised using non-disposable materials such as flexible plastic, wherein the front part of the open tray container is not removable but can be opened thus rendering it suitable for dishwashing wherein the packaging can be rewashed after use.

Other objects and features of the present invention will become apparent from the following detailed description considered in connection with the accompanying drawings, which disclose several key embodiments of the invention. It is to be understood, however, that the drawings are designed for the purpose of illustration only and that the particular descriptions of packaging applications according to different embodiments of the invention are given by way of example only and do not limit the scope of the invention.

### BRIEF DESCRIPTION OF THE DRAWINGS

The foregoing features of embodiments will be more readily understood by reference to the following detailed description, taken with reference to the accompanying drawings, in which:

FIG. 1 illustrates a schematic of the clamshell packaging design.

FIG. 2 illustrates the form of the clamshell packaging when constructed.

FIG. 3 illustrates the form of the clamshell packaging with the front part of the box removed along the serrated edge showing the moveable membrane.

FIG. 4 illustrates a schematic of the open tray packaging design.

FIG. 5 illustrates the form of one embodiment of the open tray packaging according to the invention.

FIG. 6A illustrates an alternative schematic of the open tray packaging design.

FIG. 6B illustrates the form of the open tray packaging when assembled.

FIG. 7A illustrates an alternative schematic of the clamshell open tray packaging design.

FIG. 7B illustrates the form of the clamshell packaging with the front part of the box removed along the serrated edge showing the moveable element.

FIG. 7C illustrates the form of the clamshell packaging with the upper and lower halves closed together with the front part of the box removed.

### DETAILED DESCRIPTION OF SPECIFIC EMBODIMENTS

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as defined by the appended claims. The following description makes full reference to the detailed features as outlined in the objects of the invention.

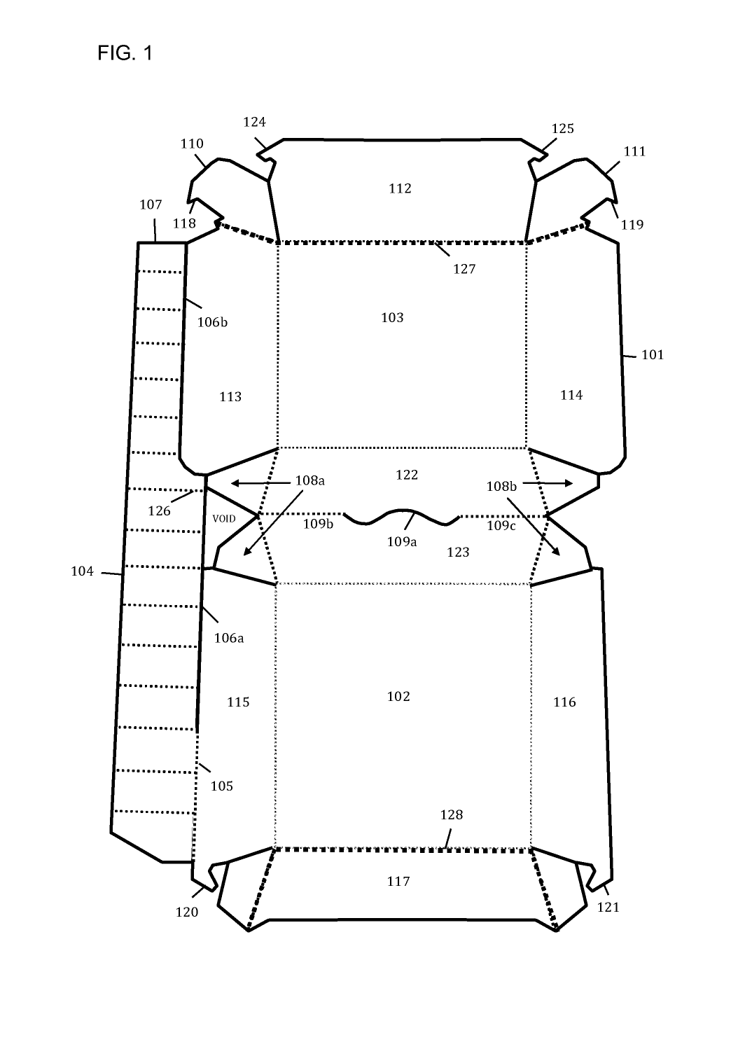

Referring now in detail to the drawings and in particular FIG. 1 thereof, therein illustrated is an example of a clamshell packaging design according to a first embodiment of the invention suitable for fast food such as a hamburger.

In a preferred embodiment, the package comprises a cardboard, or other suitable material, sheet cut from a single sheet, which can interlock together to form a clamshell container for fast food.

In the following description the word ‘serrated’ refers to an indention of the material to enable the packaging material to be folded at that location. In particular it means that the material is not completely cut through at that location.

The words ‘heavily serrated’ mean that the material is perforated sufficient that point such that part of the material may be torn off and removed along that heavily serrated section.

The clamshell container (101) comprises a base side (102) and a top side (103), which form the lower and upper side of the packaging container respectively. The two sides fold around the hinge between end elements (122, 23), which comprises a cut serpentine central element (109a), and two serrated lines (109b, 109c) either side of the serpentine cut (109a) to assist with closing the two halves of the clamshell together.

The upper clamshell part (103) comprises two side flaps (113, 114) and a front flap (112). Two corner flaps (110, 111) are located either side of the front flap (112). When assembled to form the clamshell, the corner flaps (110, 111) move in front of end flap (112) such that they are on the inside of the box when closed. The corner flaps each have an extended notch (118, 119) which each align with extended notches (124, 125) when closed. The resulting two notches each formed from the combination of notches (18 and 124, 119 and 125) respectively assist with locking to the lower half of the clamshell (102) to interlock with the notches (120, 121) on the lower side flaps (115, 116).

Inner corner flaps (108a, 108b) form the extensions to the end elements (122, 12), which are glued on the inside of the clamshell sides (113, 114, 115, 116) respectively.

A moveable membrane element (104) for the clamshell box is integral with the lower half of the clamshell box (102) along a serrated edge (105). The further extension of the moveable membrane element (104) is cut and separated from the lower and upper clamshell parts (102, 103) along cut sections (106a, 106b). The moveable membrane element comprises a number of segments, which comprises serrated lines (126) to assist the membrane element to be curved around the contents of the clamshell box when assembled. In particular, the moveable membrane element is only attached to the lower half of the clamshell box (102) along the serrated length (115) which is in this embodiment equal to the length of 3 segments.

A part of the packaging material marked ‘VOID’ is removed from the box material to leave a space between the membrane element (104) and the two inner corner flaps (108a).

As described earlier, when the box is assembled, the inner corner flaps (108a, 108b) fold along the marked serrated lines and glue to the insides of clamshell side elements (113, 114, 115, 116). The extended flaps on end element (117) fold along the serrated lines and glue to the inner sides of side elements (115, 116). The moveable membrane element (104), which is separated from the upper and lower halves of the clamshell box other than serrated line (105), then folds towards the box along the 3-segment serrated line (105). The top half of the box comprising corner flaps (110, 111) which are folded along the serrated lines on the upper side flaps (113, 114) and stuck to the inner side of end flap (112) result in the upper end face comprising two notches formed from the alignment of notches (110 and 124) and (111 and 125) respectively. These notches interlock with lower notches (120, 121).

The invention further comprises a removable section of the clamshell box, which can be removed to reveal the contents and the moveable membrane.

The upper half of the clamshell box (103) comprises a heavily serrated line (127) which runs from the corner of the upper box between side flap (113) and corner flap (110). The heavily serrated line (127) runs along the fold between the upper half (103) and end flap (112) and continues to the corner of the upper box between side flap (114) and corner flap (111).

The lower half of the clamshell box (102) comprises a heavily serrated line (128) which runs along the fold between the lower end flap (117) and extends to the two lower corners of the lower half (102) between the lower front flap (117) and the two lower side flaps (115, 116).

The heavily serrated section makes it possible for the end of the box to be completely removed along the heavily serrated lines (127, 128) to reveal the contents and the loose end of the moveable membrane, which wraps around the contents.

For a hamburger clamshell packaging design the vertical dimension of the design may be around 35 cm and the horizontal dimension may be around 18 cm. The length of the moveable membrane may be around 25 cm long. Depending upon the dimensions of the contents, the dimensions may be modified accordingly.

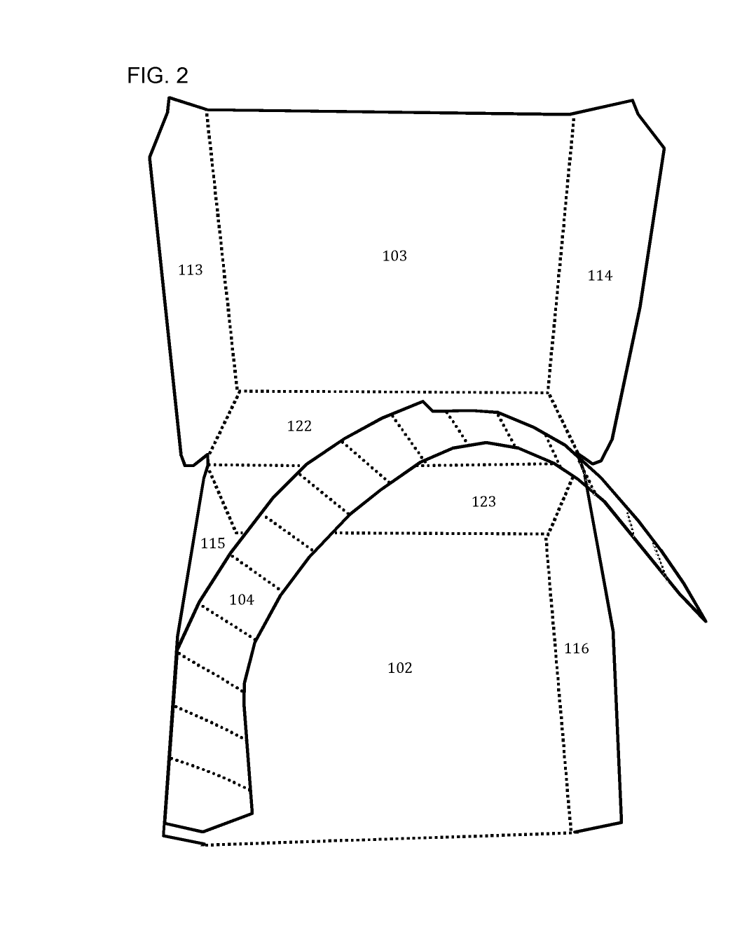

Referring now to FIG. 2, therein is shown an assembled clamshell box according to the invention with the upper and lower front sections removed along the heavily serrated lines described with reference to FIG. 1. To help understand the figure, the same reference numbers are shown which identify the same parts of the figure as in FIG. 1.

FIG. 2 shows how the assembled box looks and how the moveable membrane folds over into the box cavity and how it can wrap around the clamshell box contents.

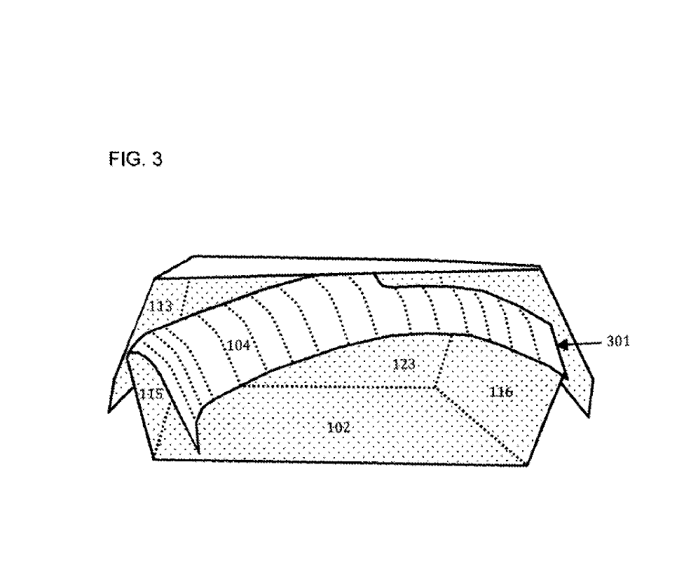

Referring now to FIG. 3, therein is shown a front view of the clamshell box with the front sections of the box removed. To help understand the figure, the same reference numbers are shown which identify the same parts of the figure as in FIG. 1.

The loose end of the moveable membrane (301) wraps around the contents of fast food packaging, which may be a hamburger. With the front sections of the box now removed, by pulling on the loose end (301) of the moveable membrane, the food is drawn towards the front of the clamshell box and can be eaten from the packaging itself.

The clamshell container might be made of cardboard or other suitable material with an appropriate coating suitable for food.

As described above, some embodiments of the present invention of a new and innovative design for clamshell packaging for fast food has some useful, economic and features which address concerns about food hygiene. It should be understood however, that the present disclosure is for the purpose of illustration only and does not include all modifications or improvements obvious to the man skilled in the art, such as the differences in relative dimensions of the design to accommodate different content dimensions, which may fall within the scope of the appended claims.

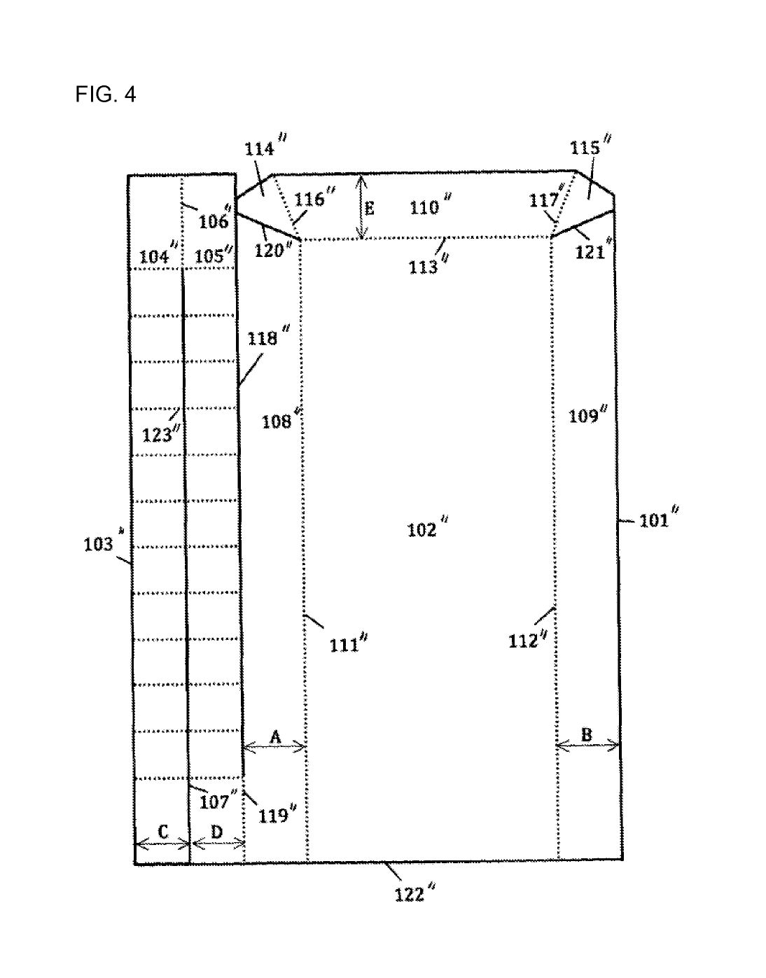

Referring now in detail to the drawings and in particular FIG. 4 thereof, therein illustrated is an example of an open tray packaging design according to a first embodiment of the invention suitable for fast food such as a hotdog or burrito and the like.

In a preferred embodiment, the package comprises a cardboard, or plastic film coated material, or other suitable material, sheet cut from a single sheet, which can be folded and glued together to form an open tray container for fast food.

In the following description the word ‘serrated’ refers to an indention or partial perforation of the material to enable the packaging material to be folded at that location. In particular it means that the material is not completely cut through at that location.

The open tray container (101″) comprises a base element (102″) and a moveable membrane element (103″), which are connected together via the serrated strip (119″). The moveable membrane element (103″) comprises two elements (104″, 105″) which are cut along line (107″) and which are joined at serrated line (106″). Membrane element (104″) folds along serrated line (106″) to close against membrane element (105″) which may be glued or fixed together in the vicinity of serrated line (106″) thereby securing the two membrane elements together.

The upper surfaces shown of the membrane elements (104″, 105″) fold downwards along serrated edge (106″) such that the two upper surfaces of the membrane elements form the outer surface of the moveable membrane (103″) when folded.

The base element (102″) comprises two side elements (108″, 109″) and an end element (110″). Side element 108″ comprises a serrated line (111″) and side element (109″) comprises a serrated line (112″) such that the side elements (108″, 109″) can be folded along the said lines (111″, 112″) respectively.

The end element (110″) is connected to the base element (102″) via a serrated line (113″), which enables the end element (110″) to be folded. In this way, side elements (108″, 109″) and end element (110″) can be folded to form a three-sided tray with an opening at the end (122″).

End element (110″) further comprises two closing flaps (114″, 115″), which are each connected to end element (110″) via serrated lines (116″, 117″) respectively. The side elements (108″, 109″) are separated from the end elements flaps (114″, 115″) along the cut edges (120″, 121″) respectively.

In a first embodiment, the moveable membrane (103″) is formed by folding element (104″) against element (105″) and gluing within the vicinity of the serrated line (106″). After this the moveable membrane is folded along line (119″) such that membrane becomes within the open tray defined by the base element (102″) and two side elements (108″, 109″) and end element (110″).

The open tray structure is formed by folding the two sides (108″, 109″) along their respective serrated edges (111″, 112″) and by folding end element (110″) along serrated edge (113″), and then fixing and or gluing flap (114″) along side element (108″) and flap (115″) along side element (109″).

The angle of the sides of the tray and the angle of the end of the tray that are made with the base element (102″) can be adapted as required. The end element and the side elements can be adapted to form a 90-degree angle with the base element (102″). Alternatively, by changing the angle of the serrated edges (116″, 117″) and the angle of the cut edges (120″, 121″), different angles of the sides of the open tray structure are formed. The moveable membrane (103″) further comprises a plurality of serrated lines (123″) to enable the membrane to move around the contents of the open tray structure.

In different embodiments the widths (A, B) of the side elements, the width of the end element (E), as well as the width of the moveable membrane elements (C, D) can be modified according to different applications.

Generally, the widths (C, D) of the membrane elements are chosen to be identical. Nevertheless, by making the widths (C, D) less than the width (A) of side element (108″), provides a moveable membrane, which does not touch the surface of the base element (102″) of the open tray structure when constructed.

Generally, the width (E) of end element (110″) will be identical to the width (A) of side element (108″). Nevertheless, in different embodiments, such as when using the open tray structure as a packaging container insert, the width (E) of end element (110″) can be extended. By varying the width (A) of side element (108″), which is connected to the moveable membrane (103″) via serrated line (119″), the position of the membrane can be changed relative to the base element (102″).

In different embodiments, where the open tray element is used as a packaging insert, the width (B) of side element (109″) can be extended by an amount equal to width of base element (102″) between the two serrated lines (111″, 112″) and by a further amount equal to the width (A) of side element (108″) such that it wraps around to form an open-ended enclosed volume.

Whenever the open tray structure is used as a packaging container insert, the serrated edges (111″, 112″, and 113″ will be folded at 90 degrees.

To adapt to different widths of tray contents, the length of the moveable membrane can be extended beyond the upper edge of the end element (110″). In this way, the length of the membrane can accommodate variations in the width of the base element (102″) and thereby make possible that the end of the membrane, which is used to pull the contents of the open tray towards the open end (122″) remains accessible.

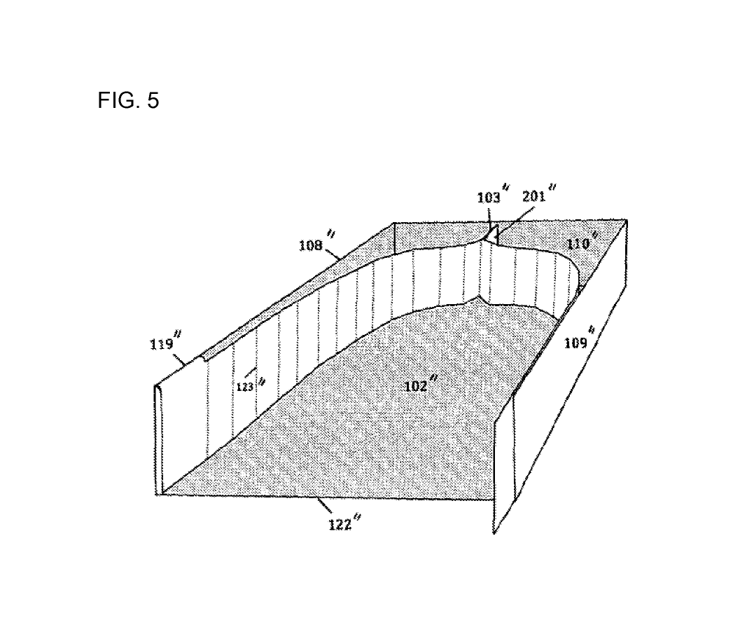

Referring now to FIG. 5, therein is shown an assembled open tray container according to the invention. To simplify the description, the same figure numbers are used in this figure where they refer to the identical figure elements as described in FIG. 4.

In particular, in FIG. 5 is shown the moveable membrane (103″) opened within a volume defined by the side elements (108″, 09″), the end element (110″), and the base element (102″). As can be seen, the moveable membrane (103″) comprising the two membrane elements (104″, 1.05″) shown in FIG. 4 are glued together in the vicinity of the serrated line (106″) to form a join element (201″).

The moveable membrane (103″) can be seen to be attached to side element (108″) by way of serrated edge (119″). Along the moveable membrane (103″) can also be seen the serrated lines (123″) which enable the membrane to curve around the contents within the tray structure (contents not shown).

The moveable membrane (103″) can be seen to extend beyond the open end (122″) of the open tray structure such that by pulling this extended end, the contents in front of the moveable membrane are pulled towards the open end.

As described earlier with respect to the application of the invention as a container insert the side element (109″) may extend by way of a serrated edge and fold around the top of the tray structure shown in FIG. 5 thereby forming a closed box with an open end. This configuration may also comprise a flap or further extension to glue to, or to attach this extended surface into, the opposite side element (108″). In this way the invention can provide an enclosed open box element to provide a versatile means for inserting contents into other outer packaging.

In particular, in other embodiments, the invention is very suitable for microwave foods by providing the means to extract food from open tray structures after they have been heated by microwave ovens. These foods are often too hot to be handled comfortably which makes the invention ideal for this application.

As described above, the present invention of a new and innovative design for open tray packaging for fast food has some useful, economic and features which address concerns about food hygiene. In addition the same open tray structure can serve to provide an effective sliding transport medium for inserting product into other containers. It should be understood however, that the present disclosure is for the purpose of illustration only and does not include all modifications or improvements obvious to the man skilled in the art, such as the differences in relative dimensions of the design to accommodate different content dimensions, which may fall within the scope of the appended claims.

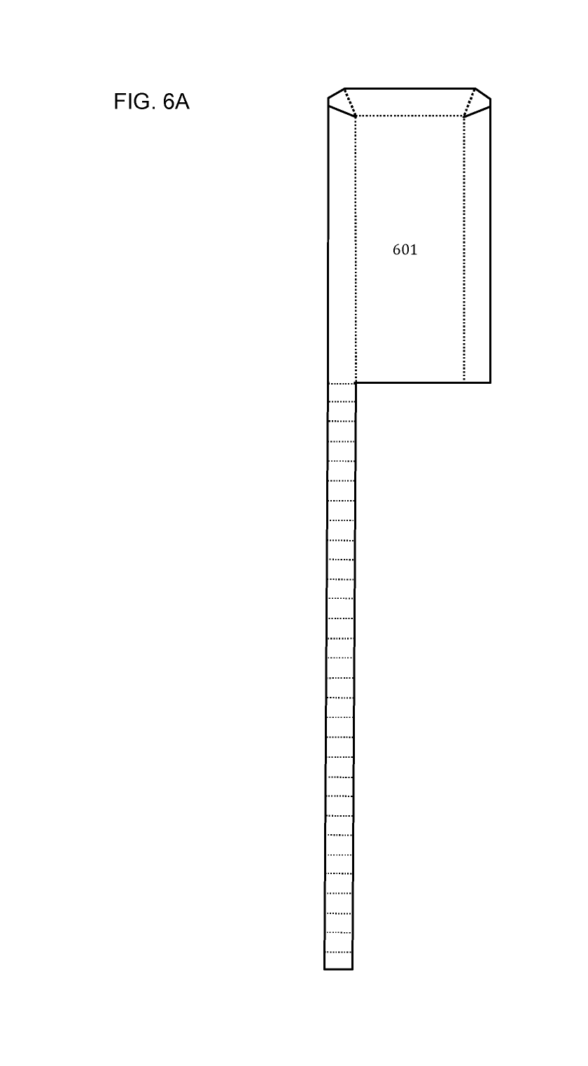

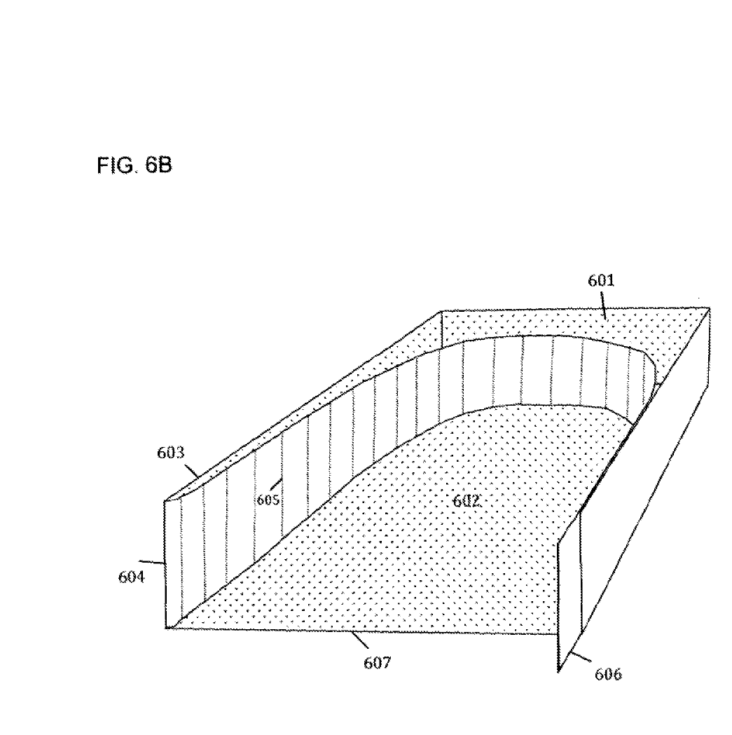

Referring now in detail to the drawings and in particular FIG. 6A thereof, therein illustrated is an alternative embodiment of the tray insert (601) with the moveable membrane element formed from extending one of the sides of the tray.

The invention shows a single sheet of material where the extended membrane element folds back into the cavity of the tray when assembled.

With reference to FIG. 6B is shown the assembled tray insert where the moveable membrane element is formed form an extension of side (603) and which folds back into the cavity (602) of the tray by way of a fold (604). Depending upon the material used this fold may comprise a perforation, or a serration or a hinge.

The moveable membrane element may comprise serrations or perforations (605) to assist with the movement of the moveable membrane element when passed around the contents of the tray and pulled by its free end (606).

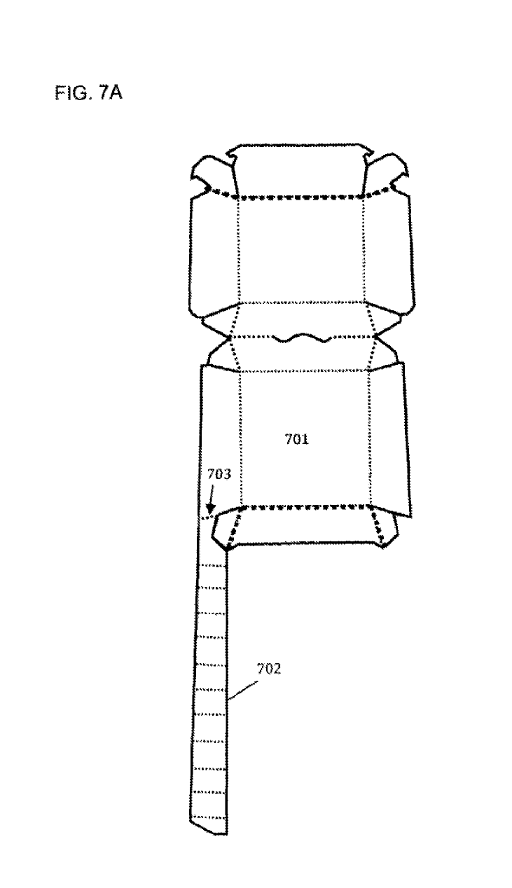

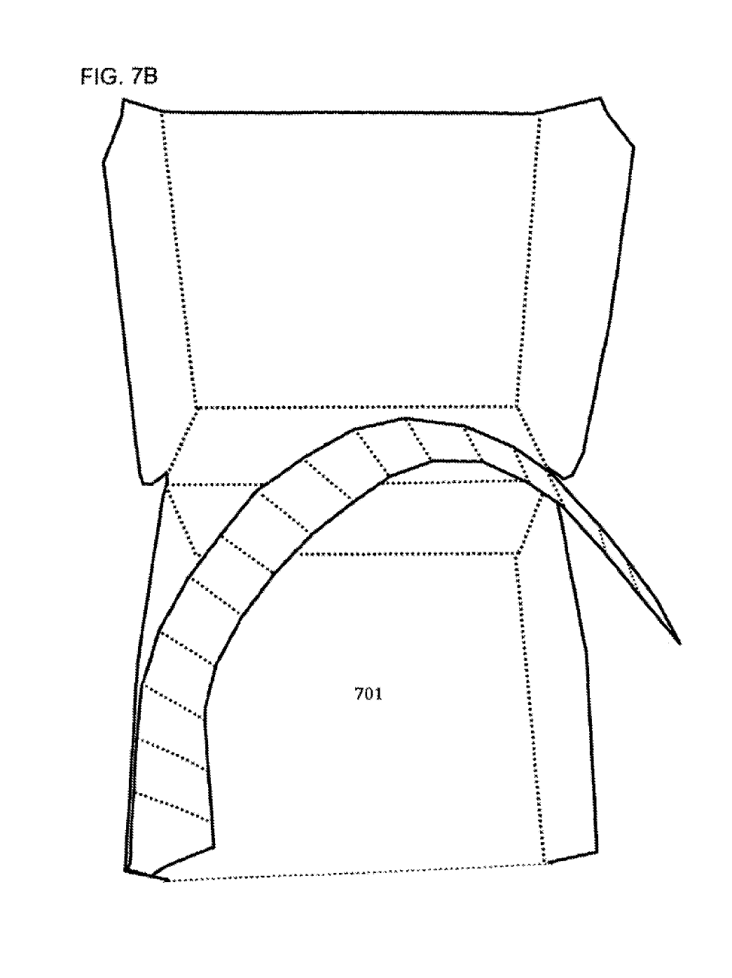

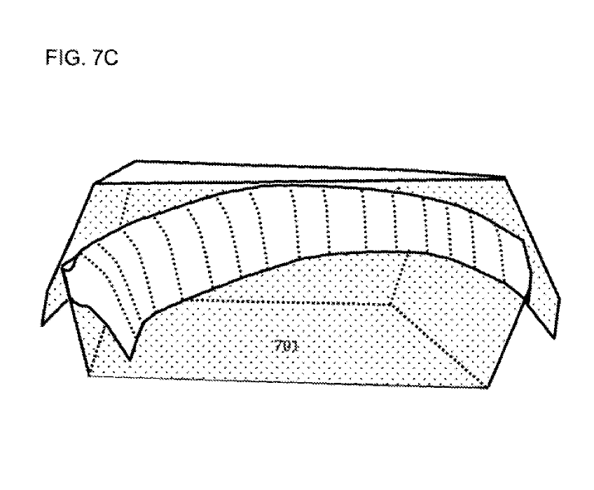

Now with reference to FIG. 7A is shown an alternative embodiment of the clamshell packaging design. The lower clamshell tray element (701) is shown with a moveable membrane element (702), which is formed from an extension of the lower left hand side element of the lower clamshell tray element (701).

FIG. 7A shows the moveable membrane element with a perforation or serration at the point where the said element will be folded into the cavity of the lower clamshell tray element.

FIG. 7B shows a three dimensional representation of the fully assembled clamshell container according to the schematic of FIG. 7A wherein the front section of the lower clamshell tray element has been removed along the serration.

FIG. 7C shows a three dimensional representation of the closed clamshell container according to the schematic shown in FIG. 7A and with the upper and lower front sections removed along their respective serrations.

As described above, the present invention of a new and innovative design for packaging for fast food has some useful, economic and features which address concerns about food hygiene. It should be understood however, that the present disclosure is for the purpose of illustration only and does not include all modifications or improvements obvious to the man skilled in the art, such as the differences in relative dimensions of the design to accommodate different content dimensions, which may fall within the scope of the appended claims.

The embodiments of the invention described above are intended to be merely exemplary; numerous variations and modifications will be apparent to those skilled in the art. All such variations and modifications are intended to be within the scope of the present invention as defined in any appended claims.

1-20. (canceled)

21. A system for packaging forming a clamshell container comprising:
a container base having at least two base side elements, a base back element and a base front element;
a container top having at least two top side elements, a top back element and a top front element; and wherein
said container base back element extending to form said container top back element thereby forming said clamshell container from a single piece of container material, and wherein
said container base and container op defining an open cavity for containing contents; and wherein
said clamshell container further comprising at least one moveable element attached to the clamshell container; and wherein
said moveable element configured to be folded around said contents when said clamshell container is closed such that the moveable element passes around said container contents and assists with the extraction of the container contents; and wherein
said container base front element being separated from said container base by at least one of a first perforation and a first serration; and
said container top front element being separated from said container top by at least one of a second perforation and a second serration; and wherein
said container top front element being removable along the at least one of a first perforation and a first serration, and said container base front element being removable along the at least one of a second perforation and a second serration, thereby forming an opening; wherein
said container contents being removable through said opening through the use of said moveable element.

22. A system for packaging forming a clamshell container according to claim 21, wherein said at least one moveable element is integrated with at least one selected from the group consisting of one or more of the at least two base side elements, one or more of the at least two top side elements, the base front element, and the top front element.

23. A system for packaging forming a clamshell container according to claim 21, wherein the container is made of disposable and/or recyclable material.

24. A system for packaging forming a clamshell container according to claim 23, wherein the disposable and/or recyclable material includes at least one selected from the group consisting of cardboard, paper, polystyrene, metal foil, Mylar foil, plastic, flexible materials, and microwave susceptor material.

25. A system for packaging forming a clamshell container according to claim 23, wherein the container material further includes at least one selected from the group consisting of a food hygiene coating, and a plastic film surface.

26. A system for packaging forming a clamshell container according to claim 21, wherein one or more of the at least two base side elements includes base tray tabs which project forward, and wherein one or more of the at least two top side element includes top tray tabs which project laterally, such that when the base element is closed with the top element to form the clamshell container, the base tray tabs interlock with the top tray tabs.

27. A system for packaging forming a clamshell container according to claim 21, wherein the base front element is removable and the top front element is able to be raised or removable, to reveal the contents, wherein a free end of the at least one moveable element extends around said contents, wherein by pulling said free end of said at least one moveable element, said contents are movable in the direction of the pulling force.
